(19) United States
(12) Patent Application Publication
(10) Pub. No.: US 2006/0161038 A1
(43) Pub. Date: Jul. 20, 2006

(54) Device and method for converting solid waste to gas

(75) Inventor: Burnard P. Bockris, Gainesville, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: World Hydrogen, Inc., Gainesville, FL (US)

(21) Appl. No.: 11/040,020

(22) Filed: Jan. 19, 2005

(51) Int. Cl. A62D 3/00

(52) U.S. Cl. 588/314

(57) ABSTRACT

A device for converting solid waste to gaseous form. The device includes a chamber for holding waste material and molten eutectics. The chamber has at least one opening for receiving the waste material into the molten eutectics. An oxygen supply and an ozone supply bring oxygen and ozone into the molten eutectics. The waste is heated by the molten eutectics and combines with the oxygen and ozone to form at least carbon dioxide, which can be removed for use, disposal, or storage. In one embodiment, a grate contains the solid material and prevents it from reaching a top surface of the molten eutectics and a blade mixes the eutectics, waste material, oxygen and ozone. Also provided is a method for converting solid waste to gaseous form.

### FIELD OF THE INVENTION

1 The present invention relates generally to waste, and more particularly relates to the conversion of solid wastes to the gaseous form.

### BACKGROUND OF THE INVENTION

Waste products can be divided into three main categories: municipal wastes; garden and farm wastes; and sewage.

Municipal wastes include typical household solid wastes, such as paper, plastic, food, and the like. Until the 1980's, most municipal wastes were disposed of by incineration. Tall chimneys emitted smoke from the burned waste into the atmosphere. The smoke contained some solids and a mixture of gases. The particles gradually fell to earth up to 25 miles away from the chimney. The gaseous product, primarily CO₂ and NO₂, added to environmental pollution.

Laws and regulations were ultimately created to prevent the spread of a community's pollution on itself and the surrounding areas. The alternative has been to create “landfills,” in which waste is compressed and piled on top of other waste and then filled over with dirt.

Landfills suffer from the disadvantages of needing large amounts of valuable land, having a maximum storage limit on each particular piece of land, emitting foul smells into the surrounding areas, allowing dangerous chemical seepage to enter water aquifers below or in the proximity of the landfill, and other similar problems.

Garden and farm wastes include waste from vegetation. Two remedies for disposing of garden and farm wastes are incineration and landfills, which suffer from the disadvantages discussed above.

The final type of waste is sewage, which includes human waste. Sewage is very hazardous to humans and animals. Disposal and handling of sewage are important problems that have led to several solutions. However, all current solutions lead to undigestable solids that are distributed over land for disposal. Rain carries down toxic remains into aquifers and other water supplies and gradually decreases the purity of the water. All current sewage disposal solutions suffer from the disadvantage of ultimately placing dangerous substances back into contact with humans.

Therefore a need exists to overcome the problems with the prior art as discussed above.

### SUMMARY OF THE INVENTION

Briefly, in accordance with one embodiment of the present invention, disclosed is a device for converting waste to safe gasses. The device includes a chamber for holding waste material and a molten substance, and an opening in the chamber for receiving the waste materials into the molten substance. An oxygen supply and an ozone supply supply oxygen and ozone into the molten substance. The waste is heated by the molten substance and combines with the oxygen and ozone to form primarily carbon dioxide.

In one embodiment of the present invention, a grate is provided in the chamber for creating a barrier that prevents the waste materials from rising to an upper surface of the molten substance.

Another embodiment of the present invention provides a method for disposing of waste. According to the method, a substance is heated beyond the melting points of the substance. Waste material is then received into the molten substance. Oxygen is then injected into the molten substance. Finally, ozone is injected into the molten substance.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is block diagram illustrating one embodiment of a waste conversion device in accordance with the present invention.

FIG. 2 is a block diagram illustrating one embodiment of a gas diffuser in accordance with the present invention.

FIG. 3 is a block diagram illustrating one embodiment of a grate in accordance with the present invention.

FIG. 4 is a flow diagram of the waste conversion process in accordance with a preferred embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention, according to one embodiment, overcomes problems with the prior art by converting solid waste into gasses. The conversion reduces the amount of solid waste that must be placed in landfills and reduces the chemicals that are available to seep into the earth and aquifers.

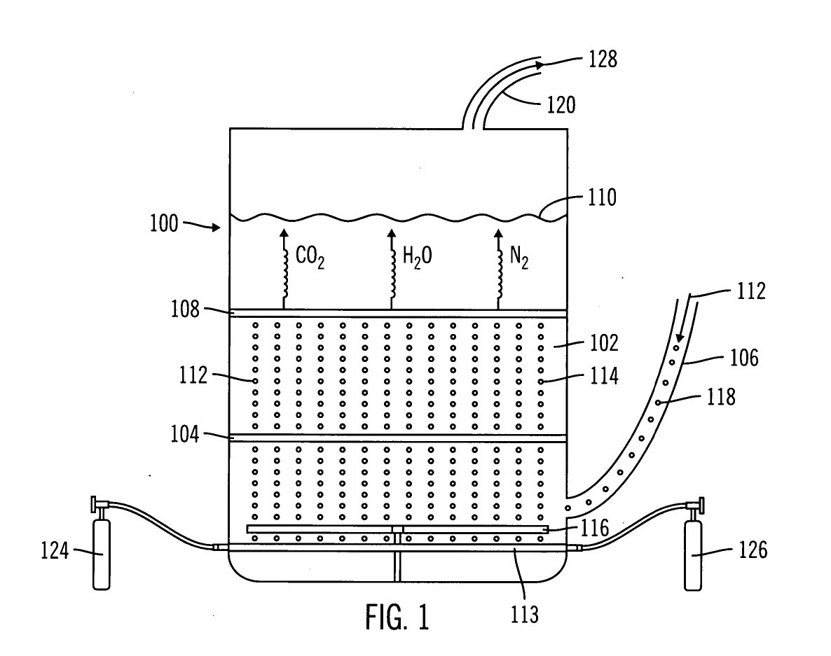

Described now is an exemplary physical structure according to an exemplary embodiment of the present invention. Referring to FIG. 1, a chamber 100, according to an exemplary embodiment, is shown. The chamber 100 is an at least partially closed vessel for containing materials and can be any shape that will contain an amount of a molten substance 102. In one embodiment, the molten substance 102 consists at least partially of salts and is referred to as “eutectics.” As will be explained later, in one embodiment of the present invention, the molten substance 102 is a mixture of molten silicates and borates for use at high temperatures. The molten substance 102 is continuously heated by an element 104. In this exemplary embodiment, the chamber 100 is closed except for parts 106 and 120.

Material wastes 118 are placed down a chute 106 that delivers the wastes 118 into the molten substance 102. A grate 108 is provided within the chamber 100 and below an upper surface 110 of the molten substance 102. The grate 108 prevents the waste 118 from rising out of the hot molten substance 102.

Into the molten substance 102 is bubbled oxygen (O₂) 112 and ozone (O₃) 114 gasses through a gas diffuser 113. To properly mix the waste 118 and gasses 112 and 114, a spinning blade 116 is provided within the chamber 100. As the blade 116 spins, the molten substance 102, waste 118 and gasses 112 and 114 interact. As a result, the carbonaceous waste 118 and gasses 112 and 114 combine to form CO₂, H₂O, and in a much smaller fraction NOₓ. One or more ports 120 near the top of the chamber removes the CO₂ for sequestration. The NOₓ can be removed for disposal, storage, or later use. The NOₓ may also be usable in fuel cells.

Describing now one embodiment of the present invention in more detail, the molten substances are eutectics, in this case, molten nitrates. Nitrates are compounds, typified by sodium nitrate and barium nitrate in a certain ratio, that result in a stable liquid of a specific melting point. Depending on the ratio of sodium nitrate and barium nitrate, which may involve metals of group IA and IIA of the Periodic Table, the melting point of the eutectics 102 can vary from approximately 400° C. to approximately 1000° C.

The particular eutectic ratio is chosen so that the eutectics temperature is about 250° C. above a decomposition temperature of the waste material 118. Typical decomposition temperatures of many organic substances are in the range of about 250-300° C. Therefore, eutectics 102 having a melting point of about 500-550° C. are particularly advantageous. However, a few organics do not decompose until 600-700° C., and hence the eutectic chosen in wastes known to contain high melting point compounds would need to have a melting point of about 850-950° C.

As stated above, eutectics are a mixture of substances. The melting point of the mixture is lower than that of each substance alone. The advantage in mixing the substances is in the fact that there is a tendency for the molten mixture to change in composition, i.e., melting point, during prolonged use. This change is undesirable. By operating at as low a temperature as possible, a greater lifecycle can be realized for the mixture. Therefore, the particular eutectics ratio is preferably chosen to provide the minimum melting point, and thus, maximum stability to the mixture.

In some rare cases, a particular material may not decompose until temperatures above those reachable with nitrate eutectics. To accommodate such high temperatures, mixtures of molten silicates and borates are used, e.g., CaO—SiO₂. Examples of chamber materials for containing such high temperatures are molybdenum and tungsten.

In one embodiment of the present invention, a heating element 104 is provided within the chamber 100 for heating the molten substance 102, and ultimately the waste material 118. The heating element is a resistive heat element or any other heating device capable of bringing the substance temperature within its desired range. In other embodiments, the heating element is outside the chamber 100 and heats the substance 102 by applying heat to a surface of the chamber 100.

The chamber material is chosen based on the desired temperature of the molten substance 102 to be contained within the chamber 100. For example, glass can be used for temperatures less than 500° C., quartz for temperatures less than 1000° C., ceramic materials for temperatures above 1000° C., and molybdenum or tungsten for temperatures up to 1800° C. Many other materials or combinations of materials are readily available and can also be used.

Into the molten substance 102 is bubbled a mixture of oxygen (O₂) 112 and ozone (O₃) 114 gas. In this embodiment, the oxygen 112 and ozone 114 come from pressurized containers 124 and 126, respectively. In further embodiments, the gasses come from any known continuous oxygen and ozone producing processes.

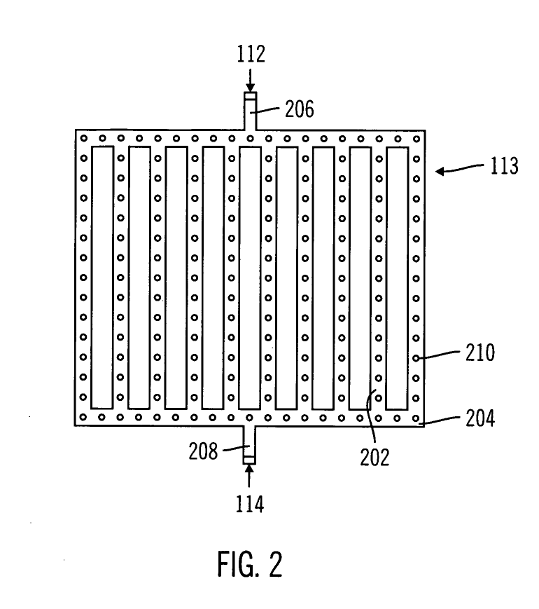

Referring now to FIG. 2, one embodiment of the gas diffuser 113 for introducing the gases 112 and 114 into the molten substance 102 is shown. It is advantageous that the bubbles be made relatively small. The diffuser 113 includes a number of inner channels 202 that are all connected by an outer channel 204. The inner channels 202 and outer channel 204 are supplied with the gases 112 and 114 through inputs 206 and 208. Each input 206 and 208 connects to a separate one of the two gas supplies.

A plurality of holes 210 in the channels 202 and 204 allow the gasses 112 and 114 to exit the channels 202 and 204 and rise through the molten substance 102. In a preferred embodiment, the bubbles are very small, which can be defined as being on the order of about 10μ (i.e. 10⁻³ cm in diameter).

In one embodiment, the rate of gas flow is at least enough for excess bubbles of oxygen to appear at the top of the molten substance 102. Other methods and devices for supplying the gasses within the molten substance 102 can be used in further embodiments and are within the spirit and scope of the present invention.

In addition, in some embodiments, the gasses 112 and 114 are mixed before entering the gas diffuser 113 or are supplied in two separate gas diffusers 113, where the two gasses 112 and 114 mix in the molten substance 102 once released from the diffuser 113. Additionally, in some embodiments, chlorine (CL₂) or hydrogen (H₂). Oxygen (O) 112 and ozone (O₃) 114, may be introduced into the molten substance 102 along with CL₂.

Additionally, in some less used embodiments, chlorine, or, separately, hydrogen, may be introduced into the molten materials containing the waste instead of oxygen and ozone. In yet another embodiment, chlorine is the substance introduced, although in this case, care is taken so that the chlorine entry is sufficiently small so that all is consumed by the waste and none escapes into the atmosphere.

In these alternative embodiments, the products for sequestration would change. With hydrogen, the primary product is methane. The chlorine would produce CCl₄ and would be used only in a preliminary treatment to break up high resistant matter. Chlorine treatment would be followed by a burst of oxygen and ozone.

The waste material 118, when exposed to the temperatures of the molten substance 102 in the presence of oxygen becomes converted, the greatest part being CO₂. When the ozone (O₃) 114 reaches the temperature of the molten substance 102, it decomposes to yield atomic oxygen (O), a powerful oxidizing agent. The O atoms and O₂ molecules are bubbled with the waste material 118 and combine with the carbon atoms produced by the decomposition of the waste material 118 in the molten substance 102. The result is CO₂, H₂O, and in a much smaller fraction NOₓ, where x represents the number of oxygen atoms. There will also be traces of other materials, according the nature of the wastes and the temperature of the molten substance. However, there are a very few organic materials that could withstand 500° C.-plus temperatures in the presence of O₂+O₃.

An exemplary chemical formula for the conversion of paper to CO₂ may be written
CₙHₘ+3/2 nO₂→nCO₂+m/2H₂O

where n and m are integers and m/2=n. The melt may also contain other elements, depending on the type and quality of the wastes.

To ensure that the molten substance 102, waste 118, and gasses 112 and 114 are properly mixed, a blade 116, or other moving object is provided within the chamber 100. As the blade 116 spins, the molten substance 102 are moved within the chamber 100, along with the waste material 118 and gasses 112 and 114. In one embodiment of the present invention, the chamber 100 is made of glass or quartz and the blade 116 is driven by magnetic induction from a motor located on the outside of the chamber 100. In another embodiment, the blade 116 is driven by a shaft attached to a motor located outside the chamber. The blade 116 can be replaced with one or more blades that move in the same direction or in different directions. Other devices or methods for stirring or mixing the solution, such as a low-frequency sonic wave generator, can be used in further embodiments without departing from the spirit and scope of the present invention.

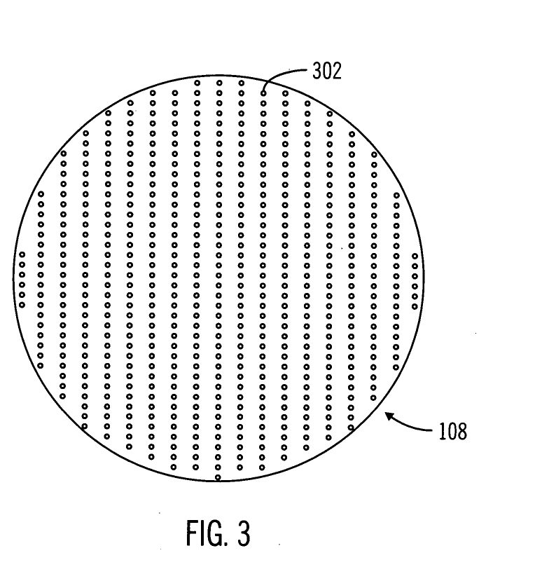

A grate 108, or screen-type structure, prevents the solid waste material 118 from rising to the surface of the molten substance. One embodiment of the grate 108 is shown in FIG. 3. As shown, the grate 108 is a circular disk with a plurality of small openings 302. The openings 302 are constructed so as to be smaller than the smallest expected piece of waste material 118. For example, in one embodiment, the openings 302 are 0.75 μm. In one embodiment, the grate 108 is removable for cleaning. In another embodiment, a scraper is provided within the chamber for clearing the grate 108 openings 302. Other embodiments of the grate 108 that prevent or inhibit solid waste material particles 118 from rising to the surface can be used in further embodiments, without departing from the spirit and scope of the present invention.

In some other embodiments of the present invention, the grate 108 is heated to a temperature greater than the average temperature of the molten substance 102 which fill the chamber 100. For instance, the grate 108 can be heated to approximately 50° C. less than the boiling point of the molten substance 102. The higher temperature of the grate 108 works to further advance the conversion of the material 118.

In one preferred embodiment of the present invention, the waste material is subjected to one or more processes aimed at reducing the particle sizes. Methods of reducing particle size are known. For instance, the wastes 118 can be subjected to chopping in a guillotine-type device. The wastes 118 can further be treated in a homogenizer. In still further embodiments, the material 118 can be placed in a mill and ground down further. Once the particles are down to about 0.1 mm or less, the material can be exposed to ultrasound, whereby the material is subject to intense vibrations, which break apart, or separate the material, and produce smaller particle sizes on the order of about 1 μm or less. Other processes, such as crushing, tearing, bending, grinding, compressing, and the like, can be used as well.

The chopped-up, powder-like material 118 is then injected into the chamber 100 near the bottom of the chamber 100. In the embodiment of FIG. 1, the waste material 118 is forced down the port 106 and into the molten substance 102 by applying O₂ under pressure. The O₂ has the added benefit of further facilitating the waste conversion process. The pressure from the O₂ also prevents the molten substance 102 from rising into the material port 106. In further embodiments, other techniques and methods that introduce the waste material 118 into the chamber 100 can be used without departing from the spirit and scope of the present invention.

The rate of material injection is dependent upon the consumption rate within the chamber 100. After the process is underway, the inflow of waste should not exceed the consumption rate. For this reason, the rate of material introduction within the chamber may be material dependent and dynamically vary as the process takes place. In one embodiment, waste does not exceed 5% of the total volume within the chamber.

Metallic materials will not combine with O₂ and O₃ to form gasses and are, therefore, not suitable for the conversion process. If the metallics are not removed, the chamber 100 may eventually become filled, thus diminishing the effectiveness of the device 100. Even light aluminum is heavier per unit volume than carbonaceous wastes. Therefore, metallic substances, in particular, aluminum, will be shaken free of the waste materials before they are introduced into the melt.

In one embodiment of the present invention, at temperatures below the Curie temperature of iron (about 800° C.), the grate 108 is magnetized so as to attract any iron-like particles within the chamber 100. The grate 108 can then be scraped or removed for cleaning and removal of the particles.

A port 120 in the chamber 100 receives the gaseous output 128 of the process described above. The output 128 is either CO₂, NOₓ, or a combination thereof. The output 128 is captured and utilized for other purposes, stored, or disposed of safely.

Although a one atmosphere environment is likely to be sufficient for the above-described waste conversion process, some waste materials may decompose more rapidly when placed under pressure. In one embodiment of the present invention, the chamber 100 is sealed and maintains a pressure of up to 10 atmospheres. Exemplary chamber materials in such embodiments are nickel and stainless steel, although for the rare cases in which temperatures are above 1250° C., other ceramic materials and atmospheres may have to be used.

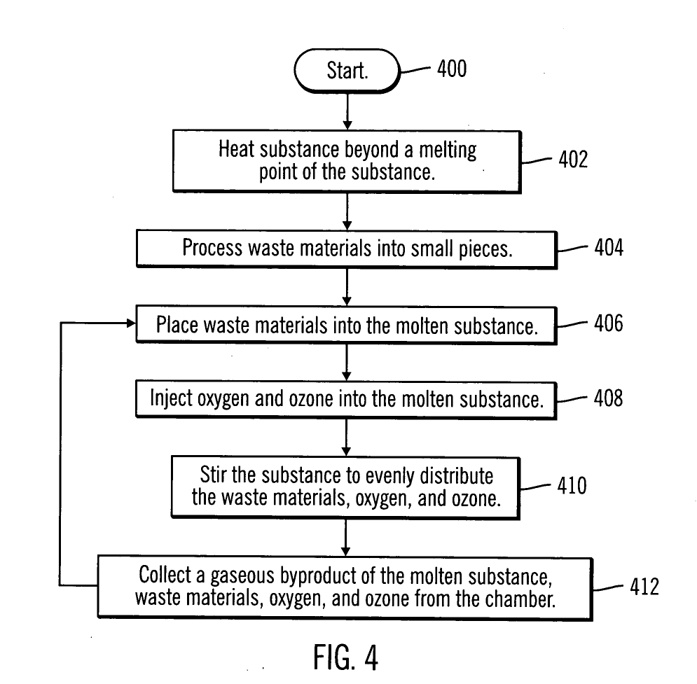

Referring now to FIG. 4, a flow chart of the process for converting waste materials according to a preferred embodiment of the present invention is shown. The process begins at step 400 and moves directly to step 402, where the substance 102 is heated sufficiently to melt the substance 102. The waste material 118 is made into small pieces in step 404. Next, in step 406, the waste material 118 is placed into the molten substance 102. Oxygen 112 and ozone 114 are injected into the molten substance 118 within the chamber 100 in step 408. The molten substance is then stirred, in step 410, to evenly distribute the waste materials 118, oxygen 112, and ozone 114. The result of the process 128 is a byproduct including CO₂, which is collected at the top of the chamber 100, in step 412. The process then returns to step 406 where more material is added to the chamber 100. While this process is shown as a series of discrete steps, in further embodiments, the steps can happen simultaneously, such as steps 408, 410, and 412.

As described above, embodiments of the present invention allow waste, whether municipal wastes, garden and farm wastes, or sewage, to be disposed of safely and efficiently by converting the waste to gaseous byproducts. The process relieves current concerns with solid waste storage. Additionally, large areas of land dedicated to the storage of solid waste can be freed for more useful purposes. Furthermore, the present invention reduces concerns regarding ground pollution and water contamination.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

What is claimed is:

1. A waste conversion device comprising:
a chamber for holding waste material;
molten substance provided within the chamber;
an opening in the chamber for receiving the waste material into the molten substance;
an oxygen supply supplying oxygen into the molten substance; and
an ozone supply supplying ozone into the molten substance,
wherein the waste material is heated by the molten substance and combines with the oxygen and ozone to form at least carbon dioxide.

2. The device according to claim 1, further comprising a grate provided in the chamber for creating a barrier that prevents the waste material from rising above an upper surface of the molten substance.

3. The device according to claim 2, wherein the grate is magnetized for attracting metallics within the waste material.

4. The device according to claim 1, wherein the molten substance is one of a eutectic and a mixture of silicates and borates.

5. The device according to claim 4, wherein a heating element heats the molten substance to approximately 500-1800° Celsius.

6. The device according to claim 1, wherein the chamber is able to maintain an applied internal pressure.

7. The device according to claim 1, further comprising:
at least one of a blade within the chamber and a sonic wave generator for stirring the molten substance and waste material.

8. The device according the claim 1, wherein oxygen gas under pressure is introduced into the opening in the chamber so as to exert pressure on the waste material entering the chamber.

9. The device according to claim 1, further comprising:
one of a chlorine supply supplying chlorine into the molten substance and a hydrogen supply supplying gas into the molten substance.

10 The device according to claim 1, further comprising:
a diffuser for releasing the oxygen and ozone into the molten substance as a plurality of small bubbles.

11. A method for disposing of waste, the method comprising the steps of:
heating a substance beyond a melting point of the substance;
placing waste material into the molten substance;
injecting oxygen into the molten substance; and
injecting ozone into the molten substance.

12. The method according to claim 11, further comprising:
reducing the size of the waste material into pieces of less than about 1 μm in size before introducing the waste material into the molten substance.

13. The method according to claim 12, further comprising:
homogenizing the waste material before placing the waste material into the molten substance.

14. The method according to claim 13, further comprising:
sonifying the waste material before placing the waste material into the molten substance.

15. The method according to claim 11, further comprising:
stirring the molten substance to more evenly distribute the waste material, oxygen, and ozone.

16. The method according to claim 11, further comprising:
collecting a gaseous byproduct of the molten substance, waste material, oxygen, and ozone.

17. The method according to claim 11, further comprising:
injecting chlorine into the molten substance.

18. The method according to claim 11, further comprising:
injecting hydrogen into the molten substance.

19. The method according to claim 11, further comprising:
pressurizing the chamber.
